(19) United States
(12) Patent Application Publication
(10) Pub. No.: US 2025/0239163 A1
(43) Pub. Date: Jul. 24, 2025

(54) VEHICLE WARNING SYSTEM AND WARNING METHOD

(71) Applicant: CARIAD (China) Co., Ltd., Beijing (CN)

(72) Inventors: Bolin SUN, Beijing (CN); Xiaoyu WEI, Beijing (CN)

(21) Appl. No.: 19/032,409

(22) Filed: Jan. 20, 2025

(30) Foreign Application Priority Data
Jan. 18, 2024 (CN) 202410075007.3

(51) Int. Cl. G08G 1/16; B60Q 1/50; G07C 5/02

(52) U.S. Cl. CPC G08G 1/166; B60Q 1/507; B60Q 1/525; G07C 5/02

(57) ABSTRACT

The present disclosure provides a vehicle warning system and warning method. Said system comprises: a driving environment evaluation module, configured to calculate a collision probability of a motor vehicle according to a collision factor, and generate and send collision probability information according to the collision probability of the motor vehicle; and a warning device, configured to receive the collision probability information sent by the driving environment evaluation module and emit a collision warning signal by flashing of a warning light according to the collision probability information, wherein a flashing frequency of the warning light increases as the collision probability increases, and the warning light is either constantly on or off when the collision probability is zero.

### TECHNICAL FIELD

The present disclosure relates to the field of traffic, and in particular, to a vehicle warning system and warning method.

### BACKGROUND

Currently, advanced driver assistance system (ADAS) and automated driving system (ADS) functions are more and more installed and used in motor vehicles. During use of the vehicle, when the ADAS function is activated or the vehicle is in an ADS mode, the personnel inside the motor vehicle may be informed of the current ADAS/ADS function status and vehicle driving status through audio prompts and display text. However, other traffic participants outside the motor vehicle are unable to know, by any fixed means or way, that the motor vehicle is being controlled by the ADAS/ADS function. Since ADAS/ADS utilizes sensors such as a radar and a camera on the vehicle to collect environmental data and in turn make a control decision, it is difficult to fully ensure the accuracy and the safety of the vehicle's control decision.

Furthermore, with the continuous increase in the number of vehicles, road safety issues have become more prominent, with frequent occurrence of serial rear-end collisions. In the prior art, many motor vehicles are equipped with assisted driving functions, such as an autonomous emergency braking (AEB) system and an adaptive cruise control (ACC) system, which focus on reducing the collision risk from the perspective of the vehicles themselves, but do not provide adequate warnings to other road users. For example, when a vehicle in an adjacent lane suddenly cuts in, a previously safe driving situation may instantly become an emergency. On low-adhesion roads in rainy or snowy weather, etc., the collision risk of the motor vehicle is increased due to deteriorated road conditions and longer braking distances.

Therefore, from the perspective of both traffic information interactivity and enhanced safety, it is urgently necessary to introduce a vehicle warning system on the vehicle, allowing other traffic participants to timely acquire information about the advanced driver assistance system (ADAS) and automated driving system (ADS) function status of the vehicle, as well as the level of danger in the current driving environment. This enables timely anticipation of safety risks and helps to avoid or reduce the occurrence of traffic accidents.

It's to be noted that the information disclosed in Background above is merely used to enhance the understanding of the background of the present disclosure, and thus may contain information that constitutes the prior art known to those skilled in the art.

### SUMMARY

To solve one or more of the problems above existing in the prior art, the present disclosure provides a vehicle warning system and a method for warning a driving status of a motor vehicle.

The present disclosure provides a vehicle warning system, comprising a warning device, which is configured to receive collision probability information sent by a driving environment evaluation module, and emit a collision warning signal by flashing of a warning light according to the collision probability information, wherein a flashing frequency of the warning light increases as the collision probability increases, and the warning light is constantly on when the collision probability is zero.

According to the vehicle warning system of an embodiment of the present disclosure, the vehicle warning system further comprises a driving environment evaluation module, which is configured to calculate a collision probability of a motor vehicle from a collision factor, and generate and send the collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition.

According to the vehicle warning system of an embodiment of the present disclosure, the vehicle warning system further comprises a driving status monitoring module, which is configured to monitor a manual driving status, an advanced driver assistance status, or an automated driving status of the motor vehicle, generate driving status information according to the manual driving status, the advanced driver assistance status, or the automated driving status, and send the driving status information to the warning device.

According to the vehicle warning system of an embodiment of the present disclosure, the warning device may further receive the driving status information sent by the driving status monitoring module, and emit a driving status warning signal through the warning light according to the driving status information.

According to the vehicle warning system of an embodiment of the present disclosure, the driving status warning signal emitted by the warning light comprises: a different color or pattern or a combination of color and pattern of the warning light, which indicate the manual driving status, advanced driver assistance status, or automated driving status of the motor vehicle, respectively.

According to the vehicle warning system of an embodiment of the present disclosure, the vehicle warning system further comprises a fault handling module, which is configured to continuously collect fault information from the driving status monitoring module, the driving environment evaluation module, and the warning device, and send an instruction to the warning device to turn off the collision warning signal and the driving status warning signal if the fault information is collected.

According to the vehicle warning system of an embodiment of the present disclosure, the warning device comprises one or more of a front warning device disposed at the front of the motor vehicle, a rear warning device disposed at the rear of the motor vehicle, a left warning device disposed on a left side of the motor vehicle, and a right warning device disposed on a right side of the motor vehicle.

The present disclosure further provides a motor vehicle, provided with the vehicle warning system as described above.

The present disclosure still further provides a vehicle warning method, comprising: emitting a collision warning signal by flashing of a warning light according to collision probability information, wherein a flashing frequency of the warning light increases as the collision probability increases, and the warning light is either constantly on or off when the collision probability is zero.

According to the vehicle warning method of an embodiment of the present disclosure, the vehicle warning method further comprises: calculating a collision probability of a motor vehicle from a collision factor; and generating and sending the collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition.

According to the vehicle warning method of an embodiment of the present disclosure, the vehicle warning method further comprises: monitoring a manual driving status, an advanced driver assistance status, and an automated driving status of the motor vehicle; generating and sending driving status information according to the manual driving status, the advanced driver assistance status, and the automated driving status; and emitting a driving status warning signal using the warning light according to the driving status information.

According to the vehicle warning method of an embodiment of the present disclosure, emitting a driving status warning signal using the warning light may comprise: displaying manual driving information, advanced driver assistance information, or automated driving information of the vehicle by means of a different color or pattern or a combination of color and pattern of the warning light.

According to the vehicle warning method of an embodiment of the present disclosure, the vehicle warning method further comprises: continuously collecting fault information during generation and sending of the collision probability information and generation and sending of the driving status information; and turning off the collision warning signal and the driving status warning signal if the fault information is collected.

The present disclosure further provides a computer apparatus, comprising a memory, a processor, and a computer program that is stored on the memory and is runnable on the processor, wherein the processor, when executing the program, implements steps of the method for warning a driving status of a motor vehicle according to the present disclosure. The present disclosure further provides a computer-readable storage medium storing thereon a computer program that, when executed by a processor, implements steps of the method for warning a driving status of a motor vehicle according to the present disclosure.

The present disclosure further provides a computer program product comprising a computer instruction that, when executed by a processor, implements steps of the method for warning a driving status of a motor vehicle according to the present disclosure.

The present disclosure allows for timely and accurate warning of the danger level of the driving environment to those outside the motor vehicle, enabling other traffic participants to timely anticipate safety risks, and thus avoiding or reducing the occurrence of traffic accidents.

### BRIEF DESCRIPTION OF THE DRAWINGS

The described and other features of the present disclosure are illustrated below in detail with reference to the particular example embodiments shown in the drawings. The example embodiments are given herein by way of illustration and thus do not limit the present disclosure, and in the drawings:

FIG. 1 is a diagram showing a vehicle warning system according to an embodiment of the present disclosure.

FIG. 2 is a diagram showing a vehicle warning system according to another embodiment of the present disclosure.

FIG. 3 is a flowchart showing a vehicle warning method according to an embodiment of the present disclosure.

FIG. 4 is a flowchart showing a vehicle warning method according to another embodiment of the present disclosure.

FIG. 5 is a diagram showing a use status of a vehicle warning system according to an embodiment of the present disclosure.

### DETAILED DESCRIPTION OF THE EMBODIMENTS

The present disclosure is described below in detail through particular embodiments to enable those of ordinary skill in the art readily practice the present disclosure according to the disclosure of this description. The embodiments described below are only part, but not all, of the embodiments of the present disclosure. All other embodiments obtained by those of ordinary skill in the art on the basis of the embodiments described in the description without creative effort shall fall within the scope of protection of the present disclosure. It should be noted that the embodiments and the features in the embodiments in the description can be combined with each other under the circumstances that there is no conflict.

In describing the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “side”, and the like indicate orientations or positional relationships on the basis of the orientations or positional relationships shown in the drawings, merely to facilitate the description of the present disclosure and simplify the description, rather than to indicate or imply that the referenced device or element must have a particular orientation and be constructed and operated in the particular orientation. Therefore, these terms may not be construed as limiting the present disclosure.

In view of the problems existing in the prior art, the inventor introduces a vehicle warning system on a motor vehicle to warn other traffic participants outside the vehicle according to a danger level of a driving environment. The flashing frequency of a warning light is adjusted according to traffic conditions and road conditions, thereby enabling other traffic participants outside the vehicle to timely anticipate safety risks, providing a more accurate and timely warning to the traffic participants, reducing the occurrence of traffic accidents, and helping to enhance the sense of security and comfort for the traffic participants.

The vehicle warning system of the present disclosure comprises a driving environment evaluation module 1 and a warning device 2, wherein the driving environment evaluation module 1 may evaluate a driving environment by means of a road adhesion coefficient, a relative speed between a motor vehicle (the vehicle) and other traffic participants, a relative distance between the vehicle and other traffic participants, a mass of the motor vehicle, and a traffic environment condition; and the warning device 2 emits a signal for indicating the danger level of the driving environment. It should be noted that the traffic environment condition described in the present disclosure comprises variables that can cause changes in traffic conditions, such as the number of traffic participants, the degree of traffic congestion, and sudden behaviors of other traffic participants (e.g., sudden lane change and cut-in and sudden braking). The present disclosure allows for timely and accurate warning of risks of the driving environment to those outside the vehicle, and enhances the traffic information interactivity of the motor vehicle, enabling other traffic participants to timely anticipate safety risks and thus avoiding or reducing the occurrence of traffic accidents.

Embodiments of the present disclosure are described below with reference to FIGS. 1-5.

### Embodiment 1

FIG. 1 is a diagram of a vehicle warning system 100 according to Embodiment 1 of the present disclosure.

As shown in FIG. 1, the vehicle warning system of the present disclosure comprises a driving environment evaluation module 1 and a warning device 2. The driving environment evaluation module 1 calculates a collision probability of a motor vehicle from a collision factor of the motor vehicle in a manual driving status, an advanced driver assistance status, or an automated driving status, and sends collision probability information according to the collision probability of the motor vehicle, the collision factor including, but not limited to, a road adhesion coefficient, a relative speed between the motor vehicle and other traffic participants, a relative distance between the motor vehicle and other traffic participants, a mass of the motor vehicle, and a traffic environment condition (such as the degree of congestion). The warning device 2 receives the collision probability information sent by the driving environment evaluation module 1, and emits a collision warning signal by flashing of a warning light according to the collision probability information, wherein a flashing frequency of the warning light increases as the collision probability increases, and the warning light is either constantly on or off when the collision probability is zero. As described in detail below, in the case where the collision probability is zero, if the motor vehicle is in the manual driving status, the warning light may be turned off (extinguished); if the motor vehicle is in the advanced driver assistance status or automated driving status, the warning light may be kept constantly on (not flashing), at which point a different color (or warning light pattern, such as a square or circular pattern) may be selected to indicate whether the vehicle is in the advanced driver assistance status or the automated driving status.

The driving environment evaluation module 1 of the present disclosure evaluates the collision risk (the collision probability) of the motor vehicle from parameters such as the road adhesion coefficient, the relative speed, the relative distance, the vehicle mass, and the traffic environment condition, and emits the collision warning signal indicating the danger level of the driving environment to those outside the motor vehicle. In particular, the road adhesion coefficient of the present disclosure is calculated using algorithms such as an extended Kalman filter (EKF), the vehicle speed is measured by a sensor or calculated by an algorithm, and the data of the traffic environment condition may be collected using apparatuses such as a camera or a millimeter-wave radar apparatus. The driving environment evaluation module 1 calculates the collision probability of the motor vehicle from the collected information, with the collision probability being set between 0% and 100%, wherein 0% indicates no collision risk at present, and a higher value indicates a higher collision risk. The collision probability may be calculated by means of a neural network or the like, such as a Bayesian neural network. First, it is necessary to select the influence factors, determine the dependencies between the factors, assign weights, and then establish a model. Then, a large amount of measured road traffic data is screened to train the model. The collision probability may be obtained by inputting the data of the influence factors to the trained model. According to an embodiment of the present disclosure, the collision probability may be divided into several risk levels (tiers) according to the calculated values, for example, into five levels, with the collision probability classified from high to low as extremely high, high, medium, low, and extremely low, and the warning device 2 then emits different warning signals accordingly.

To enable the traffic participants outside the vehicle to more easily identify the warning device 2, in the embodiment, the warning device 2 is preferably disposed on an exterior body of the motor vehicle. Of course, the arrangement of the warning device 2 is not limited to the exterior of the vehicle, and those skilled in the art may also adopt other suitable positions for installing the warning device that are easily identifiable by the traffic participants outside the vehicle. As a preferred solution of the embodiment above, the warning device 2 of the embodiment may further preferably comprise one or more of a front warning device disposed at the front of the motor vehicle, a rear warning device disposed at the rear of the motor vehicle, a left warning device disposed on a left side of the motor vehicle, and a right warning device disposed on a right side of the motor vehicle.

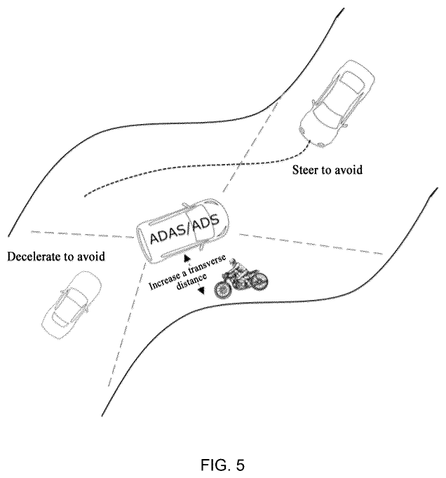

During the traveling of the motor vehicle, as shown in FIG. 5, the front warning device serves to warn oncoming vehicles, allowing them to take actions such as steering to avoid the vehicle in advance. The rear warning device may warn vehicles approaching from behind, allowing them to take actions such as deceleration to avoid the vehicle. The left warning device and the right warning device serve to warn traffic participants on the left and right sides of the motor vehicle, respectively, allowing them to maintain a safe distance in advance.

On the basis of the embodiment above, the front warning device may preferably comprise one or more warning lights disposed at the front of the motor vehicle; the rear warning device may preferably comprise one or more warning lights disposed at the rear of the motor vehicle; the left warning device may preferably comprise one or more warning lights disposed on the left side of the motor vehicle; and the right warning device may preferably comprise one or more warning lights disposed on the right side of the motor vehicle. Of course, the number and form of the warning device 2 of the present disclosure are not limited to the embodiments above. The present disclosure may also employ any other warning device that is identifiable by the traffic participants outside the vehicle, such as a ring-shaped warning light strip surrounding the vehicle body.

Further, the warning device 2 of the embodiment is preferably installed at a height greater than 250 mm and less than 1500 mm, enabling the traffic participants to look straight ahead without excessively looking down or up at an indication module.

In the environment around the vehicle, certain positions are not easily visible to the traffic participants due to blind spots. To facilitate receiving of the information of the warning light by the driver, the warning light should not be installed in these blind spots. In the embodiment, the warning device 2 is preferably installed above a door pedal and below a spoiler but should be avoided from being installed on windows, front and rear windshields, or any positions above them.

Furthermore, to ensure that the driver can see the information from the warning device 2 clearly, it is important to ensure that the installation position of the warning device 2 is easily observable. In particular, this can be achieved by adjusting the warning device 2, for example, by adjusting the angle and color of the warning light, positioning the warning light at an angle parallel to the line of sight of the traffic participants, and using a prominent color to enhance its visibility.

Finally, when installing the system of the present disclosure, it should be ensured that the installation position of the warning light complies with local regulations to avoid illegal activities and traffic accidents.

As a preferred embodiment of the present disclosure, the warning light may adopt the following installation positions:

(1) Vehicle logo as the warning light: the vehicle logo may be designed as the warning light, provided it complies with relevant regulations. The traffic participants can naturally notice the status of the warning light when looking straight ahead, without the need to shift their gaze excessively. This arrangement combines brand identity with safety functionality, resulting in improved overall practicality.

(2) Through-type warning light: using a through-type warning light at the rear or front of the vehicle makes them more eye-catching and more effective in serving for warning. Such a design may enhance vehicle recognition and provide additional safety protection under low-visibility conditions. By selecting the appropriate color and flashing frequency, such warning light can effectively warn other road users.

(3) Fender warning light: installing the warning light on a fender is a unique and practical arrangement. In the embodiment, it is preferable to install the warning light around the fender or to design the entire fender as an encircling warning light. This allows for the installation of more conspicuous warning lights on both sides of the motor vehicle, which are more likely to attract the attention of other road users, thereby enhancing driving safety.

(4) Door handle warning light: installing a warning light on a door handle may combine the warning light with an ambient light of the door handle, thereby saving production costs. At the same time, when other traffic participants approach the vehicle, the warning light on the door handle may serve as a reminder, enhancing use convenience.

On the basis of the vehicle warning system of Embodiment 1, the present disclosure further provides a motor vehicle, provided with the vehicle warning system as described above. It should be understood by those skilled in the art that in the present disclosure, a driving status monitoring module, a driving environment evaluation module, and a warning device may be adaptively installed on the motor vehicle according to different types of vehicles, different vehicle configurations, and different production and assembly platforms. This improves the traffic information interactivity and helps to avoid traffic risks arising from the advanced driver assistance system (ADAS)/automated driving system (ADS) and dangerous road conditions.

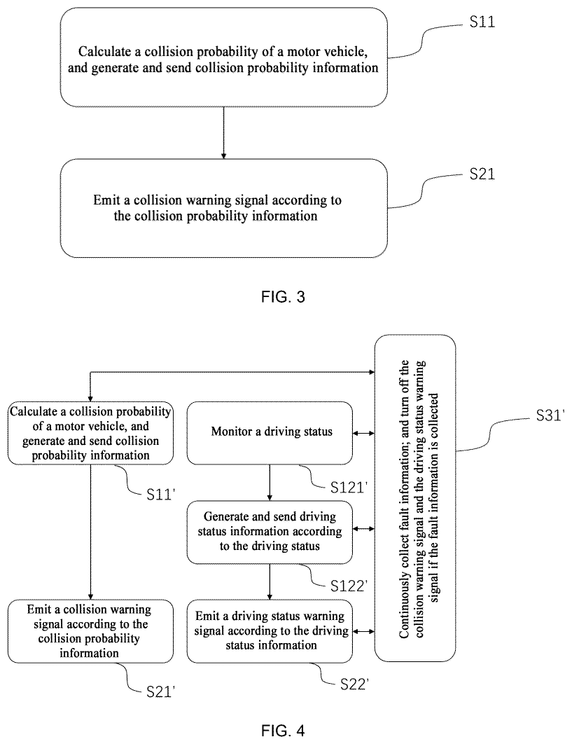

A vehicle warning method according to Embodiment 1 of the present disclosure are further described below with reference to FIG. 3. The vehicle warning method comprises the following steps:
S11: calculating a collision probability of a motor vehicle from a collision factor of the motor vehicle in a manual driving status, an advanced driver assistance status, or an automated driving status; and generating and sending collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition; and
S21: emitting a collision warning signal by flashing of a warning light according to the collision probability information, wherein a flashing frequency of the warning light increases as the collision probability increases, and the warning light is either constantly on or off when the collision probability is zero.

During use, the warning device 2 receives the collision probability information sent by the driving environment evaluation module 1. When the collision probability is greater than 0%, the warning light of the warning device 2 flashes to warn of the driving environment outside the motor vehicle. When the collision probability is zero, the warning light is either constantly on or off.

Through the embodiment above, the embodiment allows for timely and accurate displaying of the advanced driver assistance system (ADAS)/automated driving system (ADS) status to those outside the motor vehicle, as well as warning of the driving environment to those outside the vehicle, enabling other traffic participants to timely anticipate safety risks and thus avoiding or reducing the occurrence of traffic accidents.

### Embodiment 2

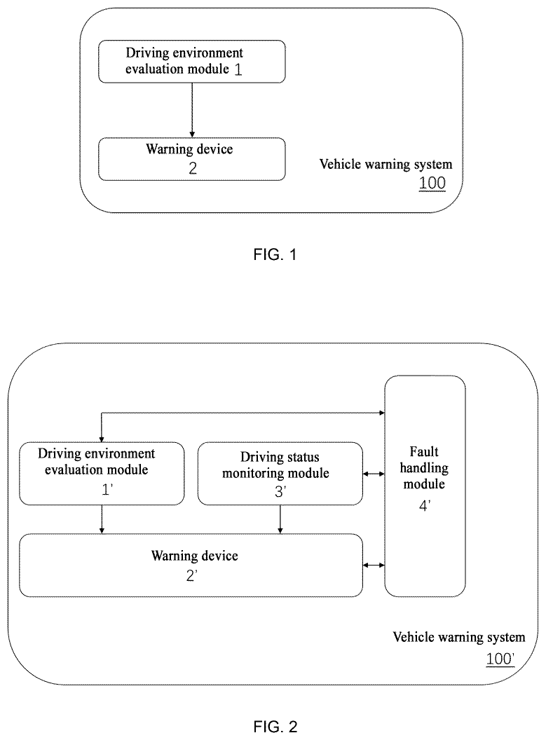

FIG. 2 is a diagram of a vehicle warning system 100′ according to Embodiment 2 of the present disclosure.

As shown in FIG. 2, the vehicle warning system according to another embodiment of the present disclosure comprises a driving environment evaluation module 1′, a warning device 2′, a driving status monitoring module 3′, and a fault handling module 4′. The driving status monitoring module 3′ monitors a driving status of a motor vehicle, that is, whether the motor vehicle is in a manual driving status, an advanced driver assistance status, or an automated driving status, and collects manual driving information, advanced driver assistance information, or automated driving information of the motor vehicle. The driving environment evaluation module 1′ calculates a collision probability of the motor vehicle from a collision factor, and generates and sends collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition. The warning device 2′ receives the collision probability information sent by the driving environment evaluation module 1′, and emits a collision warning signal by flashing of a warning light according to the collision probability information, wherein a flashing frequency of the warning light increases as the collision probability increases, and the warning light is either constantly on or off when the collision probability is zero.

Furthermore, the warning device 2′ further receives the driving status information sent by the driving status monitoring module 3′, and emits a driving status warning signal using a color and/or a pattern of the warning light according to the driving status information. By way of example, the driving status warning signal emitted by the warning light of the present disclosure optionally comprises a first color signal for indicating the manual driving status, a second color signal for indicating the automated driving status, and a third color signal for indicating the advanced driver assistance status. The first color signal, the second color signal, and the third color signal preferably comprise a constantly-on status signal for indicating that the collision probability of the motor vehicle is zero, and a flashing status signal for indicating that the collision probability of the motor vehicle is greater than zero. Such a design enables to more clearly convey the driving status and the collision probability information of the motor vehicle, helping other traffic participants to better understand and respond accordingly. In particular, when the motor vehicle is in the manual driving status, the first color signal is constantly on to indicate that the vehicle is under driver control. When the motor vehicle is in the automated driving status, the second color signal is constantly on to indicate that the vehicle is under automated driving control. When the motor vehicle is in the advanced driver assistance status, the third color signal is constantly on to indicate that the vehicle is in the advanced driver assistance status. When the second color signal and the third color signal are on, other traffic participants need to remain alert and make necessary anticipation and intervention. When the collision probability of the motor vehicle is greater than zero, the first color signal, the second color signal, and the third color signal switches to a flashing status to attract the attention of other traffic participants and remind them to take corresponding avoidance measures. Alternatively, when the motor vehicle is in the manual driving status, the warning light may also be turned off (the warning light is extinguished) if the collision probability of the motor vehicle is zero. This solution can significantly improve traffic safety and reduce the occurrence of traffic accidents. In summary, the warning light of the embodiment can clearly convey the driving status and the collision probability information of the vehicle by emitting signals of different colors and statuses, helping other traffic participants to better understand and respond accordingly, thereby improving traffic safety. It may be understood by those skilled in the art that the indication of different driving statuses has been illustrated above using different color signals, and that in practice, different driving statuses may also be represented by warning lights with different patterns or shapes, which are also within the scope of protection of the present disclosure.

The fault handling module 4′ continuously collects fault information from the driving status monitoring module 3′, the driving environment evaluation module 1′, and the warning device 2′; and the fault handling module 4′ sends an instruction to the warning device 2′ to turn off the corresponding warning signals after the fault information is collected. It may be understood by those skilled in the art that the driving status monitoring module 3′ above preferably uses a sensor, a program, or software capable of collecting advanced driver assistance and/or automated driving information of the motor vehicle, and of course, may also be a combination of a sensor, a program and software.

As shown in FIGS. 1 and 2, Embodiment 2 differs from Embodiment 1 in that: the vehicle warning system 100′ of Embodiment 2 further comprises a fault handling module 4′. The fault handling module 4′ of the embodiment is configured to monitor the operating conditions of the driving status monitoring module 3′, the driving environment evaluation module 1′, and the warning device 2′, and timely address the issue of the warning device 2′ being frequently turned on or off due to faults in the driving status monitoring module 3′, the driving environment evaluation module 1′, and the warning device 2′, thereby preventing false alarms of the warning information and improving the stability and reliability of the vehicle warning system of the present disclosure.

The embodiment makes it easier for other traffic participants to distinguish between the driving status of the motor vehicle and the warning signals of the external driving environment by changing the color and the flashing frequency of the warning light, enabling them to take corresponding actions to reduce the risk of traffic accidents. Furthermore, such changes also help to alleviate the driver's visual fatigue, as prolonged exposure to a single color and flashing frequency of a warning light may cause visual fatigue in other traffic participants, thereby affecting their judgment over and response to traffic conditions. By changing the color and the flashing frequency, the visual senses of other traffic participants may be stimulated, making them more alert and aware, thereby improving the driving safety.

It should be noted that for a motor vehicle with a higher level of automated driving, the driving status monitoring module 3′ in the vehicle warning system 100′ of the present disclosure may be configured to automatically monitor the manual driving status, advanced driver assistance status, or automated driving status of the motor vehicle. For a motor vehicle with a lower level of automated driving, such as those below the level L3, the vehicle warning system of the present disclosure may be configured such that the driver may manually send to the driving status monitoring module 3′ the manual driving status information, the advanced driver assistance status information, or the automated driving status information directly by, for example, pressing a button. Similarly, the vehicle warning system 100′ of the embodiment may also be configured such that, when the vehicle is in the manual driving status, the driver may manually activate the driving environment evaluation module 1′, or the driving environment evaluation module 1′ may be automatically activated. When the driving environment evaluation module 1′ determines that there is a risk of collision with the motor vehicle, the warning module 2′ emits a corresponding collision warning signal to the outside.

As an embodiment of the present disclosure, when the motor vehicle is in a manual driving status, the warning light of the warning module 2′ emits a green signal, indicating that the vehicle is in the manual driving status; when the motor vehicle is under advanced driver assistance, the warning module 2′ emits a yellow warning signal, indicating that the vehicle is in the advanced driver assistance status; and when the motor vehicle is under automated driving, the warning module 2′ emits a red warning signal, indicating that the vehicle is in the automated driving status. When the driving environment evaluation module 1′ determines, according to various parameters, that there is a collision risk of the motor vehicle (the collision probability greater than 0%), for example, when the road becomes slippery and the relative distance between the motor vehicle and other vehicles becomes relatively short, the warning light of the warning module 2′ may further warn of the driving environment outside the motor vehicle, preferably in a flashing manner. For example, when the motor vehicle is in the advanced driver assistance status and there is a collision risk (the collision probability greater than 0%), the yellow warning light flashes at different frequencies according to the collision probability or the collision risk level. When the collision probability is low or the collision risk level is low, the driving environment risk level is also low, and at this time, the flashing frequency of the yellow warning light is low, to remind the traffic participants to increase their attention. As the collision probability or the collision risk level increases, the flashing frequency of the warning light rises, indicating that the traffic participants need to take corresponding collision avoidance measures. When the collision probability is high or the collision risk level is high, the flashing frequency of the collision warning light is in a higher range, indicating that traffic participants need to take emergency collision avoidance measures. The warning light of the embodiment allows for timely and accurate warning of road condition risks to other traffic participants by means of flashing. For example, when a serial rear-end collision occurs on an expressway, the warning light can indicate the risk level of the current driving environment through its flashing frequency. Vehicles behind can timely obtain the risk level ahead from the flashing frequency of the road condition warning light and take appropriate preventive measures in advance.

Hereinafter, the vehicle warning method according to Embodiment 2 of the present disclosure is further described with reference to FIG. 4. In particular, the method comprises:
S11′: calculating a collision probability of a motor vehicle from a collision factor of the motor vehicle in a manual driving status, an advanced driver assistance status, or an automated driving status; and generating and sending collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition;
S21′: emitting a collision warning signal by flashing of a warning light according to the collision probability information, wherein a flashing frequency of the warning light increases as the collision probability increases, and the warning light is either constantly on or off when the collision probability is zero;
S121′: monitoring the manual driving status, the advanced driver assistance status, and the automated driving status of the motor vehicle;
S122′: generating and sending driving status information according to the manual driving status, the advanced driver assistance status, and the automated driving status;
S22′: receiving the driving status information sent by the driving status monitoring module, and emitting a driving status warning signal using the warning light according to the driving status information; and
S31′: continuously collecting fault information during generation and sending of the collision probability information and generation and sending of the driving status information, and turning off the collision warning signal and the driving status warning signal if the fault information is collected.

During use, the warning device 2′ receives the driving status information sent by the driving status monitoring module 3′ and the collision probability information sent by the driving environment evaluation module 1′. On the one hand, when the motor vehicle is in the manual status, the advanced driver assistance status, or the automated driving status, the warning device 2′ turns on the warning light of a corresponding color or turns off the warning light. On the other hand, when the collision probability is greater than 0%, the warning light of the warning device 2′ further warns of the driving environment outside the motor vehicle by flashing the warning light of the corresponding color. The fault acquisition module 4′ collects fault information generated by the driving status monitoring module 3′, the driving environment evaluation module 1′, and the warning device 2′. After the fault information is collected, an instruction to turn off a corresponding warning signal is sent to the warning device 2′. The warning device 2′ turns off the collision warning signal and/or the driving status warning signal, and step S11′ is repeated.

With the implementation of Embodiment 2, the present disclosure can effectively address the issue of the warning device being frequently turned on or off, thereby preventing false alarms of the warning information and improving the stability and reliability of the vehicle warning system. This allows the vehicle's advanced driver assistance system (ADAS) and automated driving system (ADS) function statuses to be displayed more timely and accurately to the outside of the motor vehicle, enabling other traffic participants to timely anticipate safety risks, and thus avoiding or reducing the occurrence of traffic accidents.

According to the embodiment above, the present disclosure provides a computer apparatus, which may be one that is integrated into the motor vehicle in the form of an in-vehicle computer. The computer apparatus comprises a memory, a processor, and a computer program that is stored on the memory and is runnable on the processor, wherein the processor, when executing the program, may implement the steps of the warning method for the vehicle warning system of the embodiment.

Furthermore, the present disclosure provides a computer-readable storage medium storing thereon a computer program. The computer-readable medium may be comprised in the system as described in the embodiments above or may be present separately and be not assembled in the system. The computer-readable medium above carries one or more programs which, when executed by the system, enable the system to perform the steps of the warning method for the vehicle warning system of the embodiment.

According to the embodiment above, the present disclosure further provides a computer program product comprising a computer instruction that, when executed by a processor, implements the steps of the warning method for the vehicle warning system.

In particular, the processes above of the embodiments as described with reference to the flowcharts in the drawings may be implemented as a computer software program. For example, the embodiment disclosed in the description of the present application comprises a computer program product which comprises a computer program carried on a computer-readable medium, wherein the computer program contains program codes for performing the method as shown in the flowchart in the drawings, and is executed by a processor to perform the method of the present application.

It should be noted that the computer-readable medium as described in the present application may be a computer-readable signal medium, a computer-readable storage medium or any combination thereof. The computer-readable storage medium may, for example, include, but is not limited to, electrical, magnetic, optical, electromagnetic, infrared or semiconductor systems, means or devices or any combination thereof. More particular examples of the computer-readable storage medium may include, but are not limited to, a computer disk, a hard disk, a random access memory (RAM), a read-only memory (ROM), an erasable programmable read-only memory (EPROM), a flash memory, a portable compact disk-read-only memory (CD-ROM), an optical storage device, a magnetic memory device or any suitable combination thereof.

In the present application, the computer-readable storage medium may be any tangible medium containing or storing a program that may be used by or with an instruction execution system, means or device. However, in the present application, the computer-readable signal medium may be comprised in a baseband or act as a data signal propagated as part of a carrier, in which computer-readable program codes are carried. Such data signal propagated may be of multiple forms, including, but not limited to, an electromagnetic signal, an optical signal or any suitable combination thereof. The computer-readable signal medium may also be a computer-readable medium other than the computer-readable storage medium, which may send, propagate or transmit a program for use by or with the instruction execution system, means or device. The program codes comprised in the computer-readable medium may be transmitted using any suitable medium, including, but not limited to, wirelessly, a wire, an optical cable, RF, or any suitable combination thereof.

One or more programming languages or a combination thereof may be used to compile the computer program codes for executing the operations of the present application, including an object-oriented programming language, such as Java, Smalltalk and C++, and a conventional procedural programming language such as “C” language or similar programming languages. The program codes may be fully executed on a user computer, partly executed on a user computer, executed as an independent software package, partly executed on a user computer and partly executed on a remote computer, or fully executed on a remote computer or a server. In the case of the remote computer, the remote computer may be connected to the user computer over any kind of networks including a Local Area Network (LAN) or a Wide Area Network (WAN), or may be connected to an external computer (for example, through Internet connection using an Internet service provider).

The flowcharts and the block diagrams in the drawings show, by way of example, the system architectures, functions and operations possibly implemented by the systems, methods and computer program products of all embodiments of the present application. Each block in the flowcharts or the block diagrams may represent a module, program segment or part of a code, which contain one or more executable instructions for implementing the specified logical function. It should be noted that in some alternative embodiments, the functions as labeled in the blocks may occur in an order different from that as shown in the drawings. For example, two successive blocks may, in effect, be executed substantially in parallel, or may be executed in a reverse order sometimes, depending on the functions involved. It is also to be noted that each block in the block diagrams and/or flowcharts and a combination thereof may be implemented using an application-specific hardware-based system for performing specified functions or operations, or using a combination of application-specific hardware and computer instructions.

The unit or module involved in the embodiments of the present application may be implemented by way of software or hardware. The unit or module above may also be disposed in a processor which, for example, may be described as a processor comprising an acquisition module, a subject matter generation module, and an execution module, etc. The designations of these units or modules do not impose limitations to them per se.

The embodiment collects information on each of advanced driver assistance and automated driving and emits different warning signals. The traffic participants outside the vehicle can be aware of the corresponding driving status by recognizing the different warning signals, thereby distinguishing different driving risks and enabling the traffic participants outside the vehicle to take more reasonable and safer driving measures.

In summary, according to the technical solution of the present disclosure, in particular, the following technical effects may be achieved:

(1) The present disclosure also evaluates the driving environment on the basis of the road adhesion coefficient, the relative speed to other traffic participants, the relative distance, the mass of the motor vehicle, and the traffic environment condition, warns of the danger level of the driving environment, and reduces the collision risk.

(2) The present disclosure introduces a vehicle warning system on a motor vehicle, which enhances the traffic information interactivity. It timely and accurately displays the manual driving status, the advanced driver assistance status, or the automated driving status of the vehicle to the traffic participants outside the motor vehicle, enabling the other traffic participants to timely anticipate safety risks and thus avoiding or reducing the occurrence of traffic accidents.

(3) By monitoring the fault information of the vehicle warning system, the present disclosure can effectively address the issue of the warning device being frequently turned on or off, thereby preventing false alarms of the warning information and improving the stability and reliability of the vehicle warning system.

It may be understood that the structures shown in the drawings are merely schematic and may comprise more or fewer modules or assemblies than those shown in the drawings, or may have configurations different from those shown in the drawings. It should be noted that when the present disclosure is practiced using the embodiments not exhaustively listed in the present disclosure, those skilled in the art may make adaptive adjustments to the structure, position, or function of the relevant components.

It should be understood that, where technically feasible, the technical features enumerated above for different embodiments may be combined to form additional embodiments within the scope of the present disclosure. Furthermore, the specific examples and embodiments described herein are non- limiting, and modifications to the structures, dimensions, and materials outlined above may be made without departing from the scope of protection of the present disclosure.

In the present application, the use of an adversative conjunction is intended to comprise a conjunction. The use of definite or indefinite articles is not intended to indicate a cardinal number. In particular, references to “the” object or “an” and “one” object are intended to refer to a possible one of a plurality of such objects. Furthermore, the conjunction “or” may be used to convey features that coexist, rather than indicating a mutually exclusive arrangement. In other words, the conjunction “or” should be understood as including “and/or”. The term “comprise” is inclusive and has the same scope as “include”.

The embodiments above, particularly any “preferred” or “optional” embodiments, are possible examples of embodiments and are proposed merely for a clear understanding of the principles of the present disclosure. Many variations and modifications may be made to the embodiments above without departing substantially from the spirit and principles of the techniques described herein. All modifications are intended to be included within the scope of the present disclosure.

All documents as mentioned in the description may be cited in the present application as references as if each of them is cited in the description as a reference in its entirety.

Furthermore, it should be understood that, upon reading the description above of the present disclosure, those skilled in the art may make various changes or modifications to the present disclosure, and such equivalents shall fall within the scope of protection of the present disclosure as well.

1. A vehicle warning system, comprising:
a warning device, configured to emit a collision warning signal by flashing of a warning light according to collision probability information,
wherein a flashing frequency of the warning light increases as the collision probability increases, and the warning light is either constantly on or off when the collision probability is zero.

2. The vehicle warning system according to claim 1, further comprising a driving environment evaluation module, which is configured to calculate a collision probability of a motor vehicle from a collision factor, and generate and send collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition.

3. The vehicle warning system according to claim 2, further comprising a driving status monitoring module, which is configured to monitor a manual driving status, an advanced driver assistance status, or an automated driving status of the motor vehicle, generate driving status information according to the manual driving status, the advanced driver assistance status, or the automated driving status, and send the driving status information to the warning device.

4. The vehicle warning system according to claim 3, wherein the warning device is further configured to receive the driving status information sent by the driving status monitoring module, and emit a driving status warning signal using the warning light according to the driving status information.

5. The vehicle warning system according to claim 4, wherein the driving status warning signal emitted by the warning light comprises: a different color or pattern or a combination of color and pattern of the warning light, which indicate the manual driving status, the advanced driver assistance status, or the automated driving status of the motor vehicle, respectively.

6. The vehicle warning system according to claim 4, further comprising a fault handling module, which is configured to continuously collect fault information from the driving status monitoring module, the driving environment evaluation module, and the warning device, and send an instruction to the warning device to turn off the collision warning signal and the driving status warning signal if the fault information is collected.

7. The vehicle warning system according to claim 1, wherein the warning device comprises one or more of a front warning device disposed at the front of the motor vehicle, a rear warning device disposed at the rear of the motor vehicle, a left warning device disposed on a left side of the motor vehicle, and a right warning device disposed on a right side of the motor vehicle.

8. (canceled)

9. A vehicle warning method, comprising:
emitting a collision warning signal by flashing of a warning light according to collision probability information,
wherein a flashing frequency of the warning light increases as the collision probability increases, and the warning light is either constantly on or off when the collision probability is zero.

10. The vehicle warning method according to claim 9, further comprising: calculating a collision probability of a motor vehicle from a collision factor; and generating and sending the collision probability information according to the collision probability of the motor vehicle, the collision factor comprising one or more of a road adhesion coefficient, a relative speed between the motor vehicle and other traffic participants, a relative distance between the motor vehicle and other traffic participants, a mass of the motor vehicle, and a traffic environment condition.

11. The vehicle warning method according to claim 10, further comprising:
monitoring a manual driving status, an advanced driver assistance status, and an automated driving status of the motor vehicle;
generating and sending driving status information according to the manual driving status, the advanced driver assistance status, and the automated driving status; and
emitting a driving status warning signal using the warning light according to the driving status information.

12. The vehicle warning method according to claim 11, wherein emitting a driving status warning signal using the warning light comprises: displaying manual driving information, advanced driver assistance information, or automated driving information of a vehicle by means of a different color or pattern or a combination of color and pattern of the warning light.

13. The vehicle warning method according to claim 10, further comprising: continuously collecting fault information during generation and sending of the collision probability information and generation and sending of the driving status information; and turning off the collision warning signal and the driving status warning signal if the fault information is collected.

14. A computer apparatus, comprising a memory, a processor, and a computer program that is stored on the memory and is runnable on the processor, wherein the processor, when executing the program, implements steps of the method according to claim 9.

15. (canceled)

16. (canceled)
